(19) United States
(12) Patent Application Publication
(10) Pub. No.: US 2014/0115545 A1
(43) Pub. Date: Apr. 24, 2014

(54) Method for Identifying Operation Mode of Handheld Device and Handheld Device

(71) Applicant: Huawei Device Co., LTD, Shenzhen (CN)

(72) Inventor: Zhijie Liu, Shenzhen (CN)

(73) Assignee: Huawei Device Co., LTD, Shenzhen (CN)

(21) Appl. No.: 14/136,947

(22) Filed: Dec. 20, 2013

Related U.S. Application Data
(63) Continuation of application No. PCT/CN2012/080331, filed on Aug. 20, 2012.

(30) Foreign Application Priority Data
Aug. 19, 2011 (CN) 201110240019.X

(51) Int. Cl. G06F 3/01; G06F 3/0488

(52) U.S. Cl. CPC G06F 3/017; G06F 3/0488
USPC 715/863

(57) ABSTRACT

The embodiments of the present invention provide a method for identifying an operation mode of a handheld device and a handheld device, and relate to the field of electronic technologies, to provide operational inconvenience caused by a difference between left and right hand usage habits. The method includes obtaining left and right hand operation information of a user. If the operation information indicates that the user uses the right hand to perform an operation, displaying a first preset operation interface that conforms to a right hand operation habit on a screen of the handheld device, and if the operation information indicates that the user uses the left hand to perform an operation, displaying a second preset operation interface that conforms to a left hand operation habit on the screen of the handheld device. The embodiments of the present invention are applicable to operating a handheld device.

### CROSS-REFERENCE TO RELATED APPLICATIONS

This application is a continuation of International Application No. PCT/CN2012/080331, filed on Aug. 20, 2012, which claims priority to Chinese Patent Application No. 201110240019.X, filed on Aug. 19, 2011, both of which are hereby incorporated by reference in their entireties.

### TECHNICAL FIELD

The present invention relates to the field of electronic technologies, and in particular, to a method for identifying an operation mode of a handheld device and a handheld device.

### BACKGROUND

At present, for handheld devices in markets, for example, mobile phones, screens are made larger and larger, and, to improve user experience, most of screens support touch operations. However, due to some operation modes and button layouts, and so on, it is very difficult for a user to use one hand to accomplish all operations, and sometimes, the user has to use two hands to perform an operation.

Some handheld device manufacturers have already discovered this problem, and have already launched products that are suitable for single-hand operations. However, operations on handheld devices of this type are all performed by using the right hand, which brings much inconvenience to a user that is accustomed to using a handheld device by using the left hand.

### SUMMARY

Embodiments of the present invention provide a method for identifying an operation mode of a handheld device and a handheld device, to solve a problem of operation inconvenience caused by a difference between left and right hand usage habits.

In order to achieve the foregoing objective, the embodiments of the present invention adopt the following technical solutions.

In one aspect, an embodiment of the present invention provides a method for identifying an operation mode of a handheld device. The method includes obtaining left and right hand operation information of a user. If the operation information indicates that the user uses the right hand to perform an operation, a first preset operation interface that conforms to a right hand operation habit is displayed on a screen of the handheld device. If the operation information indicates that the user uses the left hand to perform an operation, a second preset operation interface that conforms to a left hand operation habit is displayed on the screen of the handheld device.

In another aspect, an embodiment of the present invention provides a handheld device. The handheld device includes an obtaining unit configured to obtain left and right hand operation information of a user, and a displaying unit. The displaying unit is configured to, if the operation information indicates that the user uses the right hand to perform an operation, display a first preset operation interface that conforms to a right hand operation habit on a screen of the handheld device. The displaying unit is also configured to, if the operation information indicates that the user uses the left hand to perform an operation, display a second preset operation interface that conforms to a left hand operation habit on the screen of the handheld device.

In another aspect, an embodiment of the present invention provides a handheld device. The handheld device includes a touchscreen and at least two sensors, respectively located on two sides on the left and right of the handheld device, and configured to obtain left and right hand operation information of a user. The handheld device further includes at least one processor, coupled to the touchscreen and connected to the sensors, the processor being configured to, if the operation information indicates that the user uses the right hand to perform an operation, display a first preset operation interface that conforms to a right hand operation habit on the touchscreen of the handheld device. If the operation information indicates that the user uses the left hand to perform an operation, the processor is configured to display a second preset operation interface that conforms to a left hand operation habit on the touchscreen of the handheld device.

In another aspect, an embodiment of the present invention provides a handheld device, which includes a touchscreen and a user interface, configured to receive left and right hand operation information input by a user. The handheld device also includes at least one processor, coupled to the touchscreen and connected to the user interface, configured to, if the operation information indicates that the user uses the right hand to perform an operation, display a first preset operation interface that conforms to a right hand operation habit on the touchscreen of the handheld device, and if the operation information indicates that the user uses the left hand to perform an operation, display a second preset operation interface that conforms to a left hand operation habit on the touchscreen of the handheld device.

With the method for identifying an operation mode of a handheld device and the handheld device provided in the embodiments of the present invention, left and right hand operation information of a user is obtained. If the operation information indicates that the user uses the right hand to perform an operation, a first preset operation interface that conforms to a right hand operation habit is displayed on a screen of the handheld device, and if the operation information indicates that the user uses the left hand to perform an operation, a second preset operation interface that conforms to a left hand operation habit is displayed on the screen of the handheld device. In this way, according to a difference between left and right hand operations of a user, a preset interface corresponding to a left or right hand operation habit can be displayed, and it is convenient for the user to use the left hand or the right hand to perform a single-hand operation.

### BRIEF DESCRIPTION OF DRAWINGS

To describe the technical solutions in the embodiments of the present invention, the following briefly introduces the accompanying drawings for describing the embodiments. The accompanying drawings in the following description show only some embodiments of the present invention, and persons of ordinary skill in the art will realize that other embodiments are included within the scope of this disclosure.

FIG. 1 is a schematic flowchart of a method for identifying an operation mode of a handheld device according to an embodiment of the present invention;

FIG. 2 is a schematic diagram of a sensor of a handheld device according to an embodiment of the present invention;

FIG. 3 is a schematic structural diagram of a handheld device according to an embodiment of the present invention;

FIG. 4 is a schematic structural diagram of a handheld device according to another embodiment of the present invention;

FIG. 5 is a schematic structural diagram of a handheld device according to still another embodiment of the present invention; and

FIG. 6 is a schematic structural diagram of a handheld device according to yet another embodiment of the present invention.

### DETAILED DESCRIPTION OF ILLUSTRATIVE EMBODIMENTS

The following clearly describes the technical solutions in the embodiments of the present invention with reference to the accompanying drawings in the embodiments of the present invention. The embodiments described herein are merely a part of rather than all of the embodiments of the present invention. All other embodiments obtained by persons of ordinary skill in the art based on the embodiments of the present invention without creative efforts shall fall within the protection scope of the present invention.

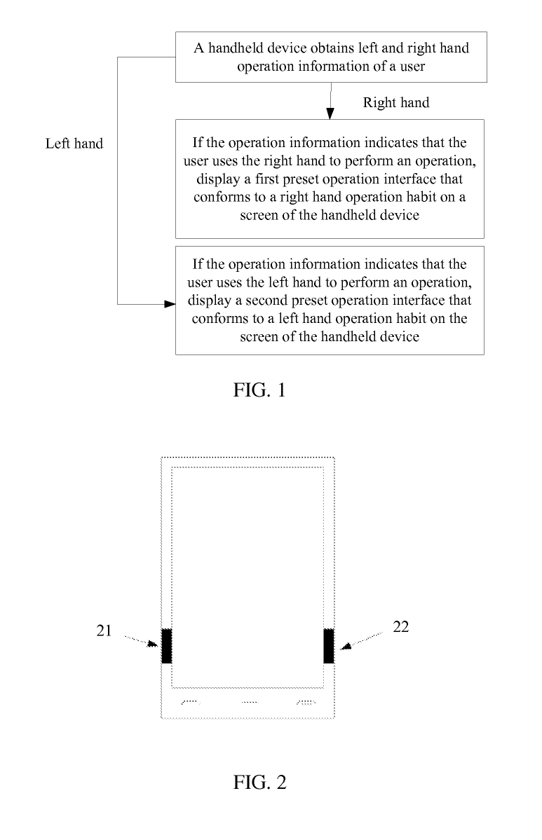

An embodiment of the present invention provides a method for identifying an operation mode of a handheld device. As shown in FIG. 1, the method includes the following steps.

S10. Obtain left and right hand operation information of a user.

Exemplarily, a specific obtaining manner may be obtaining the left and right hand operation information of the user by using sensors located on two sides on the left and right of the handheld device, and may also be obtaining the left and right hand operation information of the user by receiving left and right hand operation information input by the user.

S11. If the operation information indicates that the user uses the right hand to perform an operation, display a first preset operation interface that conforms to a right hand operation habit on a screen of the handheld device.

S12. If the operation information indicates that the user uses the left hand to perform an operation, display a second preset operation interface that conforms to a left hand operation habit on the screen of the handheld device.

In this way, according to a difference between left and right hand operations of a user, a preset interface corresponding to a left or right hand operation habit can be displayed, and it is convenient for the user to use the left hand or the right hand to perform a single-hand operation.

A method for identifying an operation mode of a handheld device provided in another embodiment of the present invention is described by taking a touch-screen mobile phone with sensors set on two sides on the left and right as an example.

A manufacturer presets two sets of operation interfaces in a mobile phone in this embodiment during production, that is, a first operation interface corresponding to a right hand operation habit and a second operation interface corresponding to a left hand operation habit. In addition, a sensor is set on each of two sides on the left and right of the mobile phone, as shown in FIG. 2, in the embodiment, which may be an optical sensor 21 and an optical sensor 22.

When a user operates a mobile phone by using a single hand, if the left hand is used, the palm of the left hand contacts the optical sensor 21 on the left side of the mobile phone, and the optical sensor 21 is covered and the amount of light changes. Therefore, it is determined that the user currently uses the left hand to perform an operation. In this case, the mobile phone displays a second preset operation interface that conforms to a left hand operation habit on the screen.

Likewise, if the user uses the right hand, the palm of the right hand contacts the optical sensor 22 on the right side of the mobile phone, and the optical sensor 22 is covered and the amount of light changes. Therefore, it is determined that the user currently uses the right hand to perform an operation. In this case, the mobile phone displays a first preset operation interface that conforms to a right hand operation habit on the screen.

With the method for identifying an operation mode of a handheld device provided in the embodiment of the present invention, left and right hand operation information of a user is obtained by using sensors located on two sides on the left and right of the handheld device. If the operation information indicates that the user uses the right hand to perform an operation, a first preset operation interface that conforms to a right hand operation habit is displayed on a screen of the handheld device, and if the operation information indicates that the user uses the left hand to perform an operation, a second preset operation interface that conforms to a left hand operation habit is displayed on the screen of the handheld device. In this way, according to a difference between left and right hand operations of a user, a preset interface corresponding to a left or right hand operation habit can be displayed, and it is convenient for the user to use the left hand or the right hand to perform a single-hand operation.

It should be noted that, that the sensors in the embodiment are optical sensors is only an example, to which the embodiments of the present invention are not limited. Another sensor that can obtain left and right hand operation information of a user is also available, for example, a proximity sensor. When the left hand or the right hand of a user approaches to a certain distance from a proximity sensor, a handheld device can obtain left and right hand operation information of the user.

A method for identifying an operation mode of a handheld device provided in still another embodiment of the present invention is described by taking a touch-screen mobile phone as an example.

A manufacturer presets two sets of operation interfaces in a mobile phone in this embodiment during production, that is, a first operation interface corresponding to a right hand operation habit and a second operation interface corresponding to a left hand operation habit.

When a user uses a mobile phone provided in the embodiment, the user may first enter a menu option of the mobile phone, and then set a single-hand operation habit in the menu option. After setting and saving, the mobile phone receives left and right hand operation information input by the user, and can determine, according to the left and right operation information, whether the user uses the right hand or the left hand. If it is determined that the user uses the right hand to perform an operation, a first preset operation interface that conforms to a right hand operation habit is displayed on a screen, and if it is determined that the user uses the left hand to perform an operation, a second preset operation interface that conforms to a left hand operation habit is displayed on the screen.

In addition, a hardware switch may also be disposed on the mobile phone. By toggling the hardware switch, a left or right hand operation habit of a user is set. It should be noted that, various types of methods for manually setting a left or right hand operation habit may also exist, which are not listed one by one herein.

With the method for identifying an operation mode of a handheld device provided in the embodiment of the present invention, left and right hand operation information input by a user is received. If the operation information indicates that the user uses the right hand to perform an operation, a first preset operation interface that conforms to a right hand operation habit is displayed on a screen of the handheld device, and if the operation information indicates that the user uses the left hand to perform an operation, a second preset operation interface that conforms to a left hand operation habit is displayed on the screen of the handheld device. In this way, according to a difference between left and right hand operations of a user, a preset interface corresponding to a left or right hand operation habit can be displayed, and it is convenient for the user to use the left hand or the right hand to perform a single-hand operation.

It should be noted that, the handheld device in the foregoing embodiments is described by taking a mobile phone as an example. However, the embodiments of the present invention are not limited to this, and other types of handheld devices are all available.

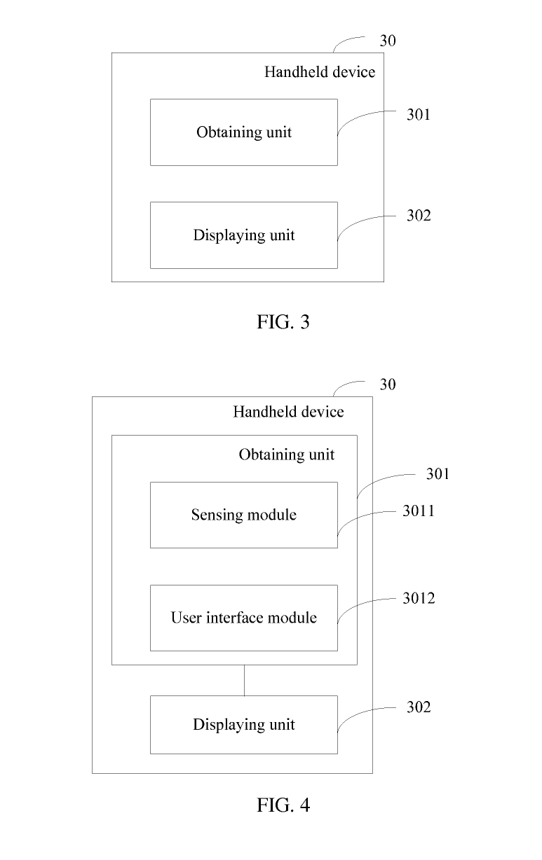

A handheld device 30 provided in an embodiment of the present invention, as shown in FIG. 3, includes an obtaining unit 301, configured to obtain left and right hand operation information of a user. The handheld device 30 also includes a displaying unit 302, configured to, if the operation information indicates that the user uses the right hand to perform an operation, display a first preset operation interface that conforms to a right hand operation habit on a screen of the handheld device, and if the operation information indicates that the user uses the left hand to perform an operation, display a second preset operation interface that conforms to a left hand operation habit on the screen of the handheld device.

In this way, according to a difference between left and right hand operations of a user, a preset interface corresponding to a left or right hand operation habit can be displayed, and it is convenient for the user to use the left hand or the right hand to perform a single-hand operation.

Further, as shown in FIG. 4, the obtaining unit 301 includes one or two of at least two sensing modules 3011 and a user interface module 3012. The at least two sensing modules 3011, respectively located on two sides on the left and right of the handheld device, are configured to obtain the left and right hand operation information of the user. The user interface module 3012 is configured to receive the left and right hand operation information input by the user.

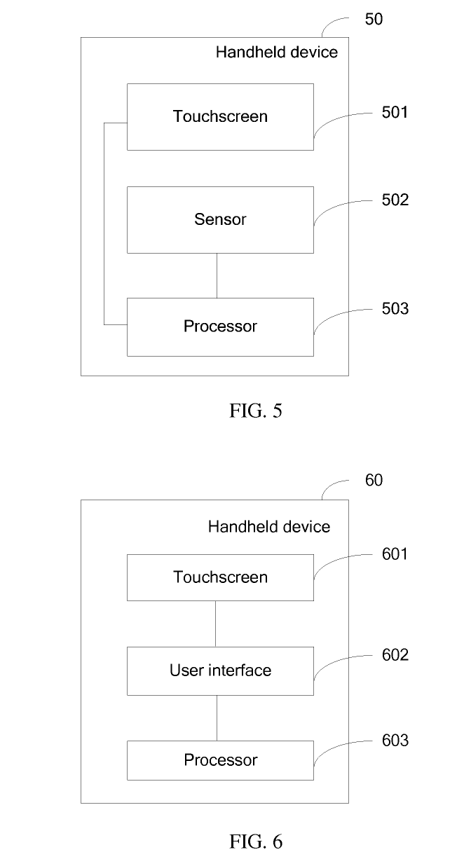

A handheld device 50 provided in another embodiment of the present invention, as shown in FIG. 5, includes a touchscreen 501, at least two sensors 502, and at least one processor. The at least two sensors 502, respectively located on two sides on the left and right of the handheld device 50, are configured to obtain left and right hand operation information of a user. The at least one processor 503, coupled to the touchscreen 501 and connected to the sensors 502, is configured to, if the operation information indicates that the user uses the right hand to perform an operation, display a first preset operation interface that conforms to a right hand operation habit on the touchscreen 501 of the handheld device 50, and if the operation information indicates that the user uses the left hand to perform an operation, display a second preset operation interface that conforms to a left hand operation habit on the touchscreen 501 of the handheld device 50.

The sensors 502 may include an optical sensor or a proximity sensor.

The handheld device provided in the embodiment of the present invention obtains left and right hand operation information of a user by using sensors on two sides on the left and right of the handheld device. If a processor determines that the operation information indicates that the user uses the right hand to perform an operation, displays a first preset operation interface that conforms to a right hand operation habit on a touchscreen of the handheld device, and if the processor determines that the operation information indicates that the user uses the left hand to perform an operation, displays a second preset operation interface that conforms to a left hand operation habit on the touchscreen of the handheld device. In this way, according to a difference between left and right hand operations of a user, a preset interface corresponding to a left or right hand operation habit can be displayed, and it is convenient for the user to use the left hand or the right hand to perform a single-hand operation.

A handheld device 60 provided in still another embodiment of the present invention, as shown in FIG. 6, includes a touchscreen 601, a user interface 602 configured to receive left and right hand operation information input by a user, and at least one processor 603, coupled to the touchscreen 601 and connected to the user interface 602. The processor 603 is configured to, if the operation information indicates that the user uses the right hand to perform an operation, display a first preset operation interface that conforms to a right hand operation habit on the touchscreen 601 of the handheld device 60, and if the operation information indicates that the user uses the left hand to perform an operation, display a second preset operation interface that conforms to a left hand operation habit on the touchscreen 601 of the handheld device 60.

The handheld device provided in the embodiment of the present invention receives left and right hand operation information input by a user; if a processor determines that the operation information indicates that the user uses the right hand to perform an operation, displays a first preset operation interface that conforms to a right hand operation habit on a touchscreen of the handheld device; and if the processor determines that the operation information indicates that the user uses the left hand to perform an operation, displays a second preset operation interface that conforms to a left hand operation habit on the touchscreen of the handheld device. In this way, according to a difference between left and right hand operations of a user, a preset interface corresponding to a left or right hand operation habit can be displayed, and it is convenient for the user to use the left hand or the right hand to perform a single-hand operation.

The foregoing descriptions are only specific embodiments of the present invention, but are not intended to limit the protection scope of the present invention. Any variation or replacement readily figured out by persons skilled in the art within the technical scope disclosed in the present invention shall all fall within the protection scope of the present invention. Therefore, the protection scope of the present invention shall be subject to the protection scope of the claims.

What is claimed is:

1. An method for identifying an operation mode of a handheld device, comprising:
obtaining hand operation information of a user;
when the hand operation information indicates that the user uses a right hand to perform an operation, displaying a first preset operation interface that conforms to a right hand operation habit on a screen of the handheld device; and
when the hand operation information indicates that the user uses a left hand to perform an operation, displaying a second preset operation interface that conforms to a left hand operation habit on the screen of the handheld device.

2. The method according to claim 1, wherein the obtaining the hand operation information of the user comprises:
obtaining the hand operation information of the user by using sensors located on a left hand side of the handheld device and on a right hand side of the handheld device.

3. The method according to claim 2, wherein the sensors comprise an optical sensor or a proximity sensor.

4. The method according to claim 1, wherein the obtaining hand operation information of a user comprises:
receiving the hand operation information input by the user.

5. A handheld device, comprising:
an obtaining unit configured to obtain hand operation information of a user; and
a displaying unit configured to display a first preset operation interface that conforms to a right hand operation habit on a screen of the handheld device when the operation information indicates that the user uses the right hand to perform an operation, and configured to display a second preset operation interface that conforms to a left hand operation habit on the screen of the handheld device when the operation information indicates that the user uses the left hand to perform an operation.

6. The handheld device according to claim 5, wherein the obtaining unit comprises at least one of a user interface module and at least two sensing modules;
wherein at least two of the at least two sensing modules being located on opposing sides of the handheld device, the at least two sensing modules configured to obtain hand operation information of the user; and
wherein the user interface module is configured to receive operation information input by the user.

7. A handheld device, comprising:
a touchscreen;
at least two sensors, at least two of the sensors being located on two sides of the handheld device, the at least two sensors configured to obtain hand operation information of a user; and
at least one processor coupled to the touchscreen and connected to the sensors, wherein the processor is configured to, when the hand operation information indicates that the user uses a right hand to perform an operation, display a first preset operation interface that conforms to a right hand operation habit on the touchscreen of the handheld device, and when the hand operation information indicates that the user uses a left hand to perform an operation, display a second preset operation interface that conforms to a left hand operation habit on the touchscreen of the handheld device.

8. The handheld device according to claim 7, wherein the at least two sensors comprise an optical sensor or a proximity sensor.

9. A handheld device, comprising:
a touchscreen;
a user interface configured to receive hand operation information input by a user; and
at least one processor, coupled to the touchscreen and connected to the user interface, wherein the processor is configured to, when the hand operation information indicates that the user uses a right hand to perform an operation, display a first preset operation interface that conforms to a right hand operation habit on the touchscreen of the handheld device, and when the hand operation information indicates that the user uses a left hand to perform an operation, display a second preset operation interface that conforms to a left hand operation habit on the touchscreen of the handheld device.
